(19) United States
(12) Patent Application Publication
(10) Pub. No.: US 2015/0192272 A1
(43) Pub. Date: Jul. 9, 2015

(54) SYSTEM FOR PRODUCING COLOR TRANSFORMABLE LIGHT

(71) Applicants: John S. Berg, Franklin, MA (US); Dimitur Benchev, Norwood, MA (US)

(72) Inventors: John S. Berg, Franklin, MA (US); Dimitur Benchev, Norwood, MA (US)

(21) Appl. No.: 14/590,865

(22) Filed: Jan. 6, 2015

Related U.S. Application Data
(60) Provisional application No. 61/924,073, filed on Jan. 6, 2014.

(51) Int. Cl. F21V 9/10; F21K 99/00; F21V 14/08

(52) U.S. Cl. CPC F21V 9/10; F21V 14/08; F21K 9/58; F21K 9/56

(57) ABSTRACT

A system for producing color transformable light includes a light source designed to emit blue excitation light and a color transformer adapted to selectively absorb and reemit the blue excitation light as green light and/or red light. The color transformer includes a transparent slide that includes a first region embedded with red phosphor, a second region embedded with green phosphor and a third region in the absence of phosphors. An apparatus retains and selectively moves the color transformer relative to the light source, such as through translational or rotational displacement. Accordingly, by displacing the position of each region in color transformer relative to the light source, the amount of blue, green and red in the output light can be adjustably mixed to yield a particular color. An optical component, such as a lens, is situated with the color transformer at its focal point and serves to focus the output light.

### FIELD OF THE INVENTION

The present invention relates generally to illumination devices and, more particularly, to systems adapted to emit color variable light.

### BACKGROUND OF THE INVENTION

Color variable light systems are illumination devices that are capable of producing output light that can be modified in perceived color. In the art, a variety of distinct techniques are utilized in the construction of such systems to modify the perceived color of output light produced therefrom to suit the needs of a particular application.

For example, one type of color variable light system which is well known in the art is a color spotlight. A color spotlight is typically constructed using a conventional light source designed to emit very bright white light (i.e. light with wavelengths spanning the entire visible spectrum) and one or more color filters. In use, the color filters are positioned relative to the light source in order to block, or filter, certain undesired wavelengths from the white light, thereby resulting in the emission of light within the desired, or target, wavelength range to produce a desired perceived color.

Although well known in the art, color spotlights of the type as described above have been found to suffer from a notable shortcoming. Specifically, color spotlights are highly inefficient and wasteful in nature, since the majority of the light produced by the light source is ultimately blocked by the color filters.

To ameliorate the aforementioned shortcoming, color spotlights have been recently redesigned using a different light source. Specifically, in place of a single light source designed to emit very white bright light, greater efficiency color spotlights utilize a set of light emitting diodes (LEDs), with each LED designed to produce light of a particular color within the spectrum of visible light. Most often, LED-based color spotlights include separate red, green and blue LEDs that are coupled with optics to direct each source of light towards a common target in an overlapping (i.e. mixed) fashion. Consequently, by adjusting the relative intensity of each of the differently colored LEDs, the light produced from the multiple LEDs can be mixed to create a composite output light of a desired color, with the range of creatable colors falling within the human eye chromaticity range defined by the selected wavelength coordinates of the three constituent colors.

Although effective in producing variable color light in a more efficient manner, LED-based color spotlights have been found to suffer from a notable shortcoming. Specifically, the utilization of multiple, separate LEDs creates certain imperfections when the various light beams produced by the individual LEDs are mixed together by corresponding optical components. Most notably, because the light produced from each of the plurality of LEDs does not originate from the same point, the resultant light beams cannot overlap perfectly at one point in space. Rather, the periphery of the mixed light typically displays the constituent, or base, colors. The aforementioned effect can often be resolved using diffusers, which serve to smooth out ineffective peripheral mixing of light by either scattering each light beam or widening its beam angle. However, these techniques compromise the efficiency in which the light is used, as a greater portion of light is wasted.

A color transformable light system is a type of color variable light system that relies on wavelength transformation of a source light to produce output light of a particular color. An example of a color transformable light system which is well known in the art utilizes phosphors for converting light produced from a light source to a desired wavelength range. For instance, conventional fluorescent lights often apply a phosphor coating to the inner surface of the outer bulb, or tube. In use, ultraviolet (UV) light produced by mercury vapor in the bulb is transformed by the static phosphor coating into additional wavelengths of color, thereby broadening the spectrum of wavelengths for the output light. Due to this expansion in the wavelength spectrum, the output light is afforded a highly distinctive, white fluorescent color.

Although well known in the art, phosphors are typically utilized in color transformable light systems to create output light of a specific, unmodifiable color (i.e. to yield hues of white light). However, such light systems are not generally designed to produce light that can be modified into distinct perceivable colors within a particular range in the visible spectrum (i.e. to produce one or more specific, non-white colors) because the entirety of the relatively diffuse source of light cannot be easily focused into a properly mixed collimated beam.

### SUMMARY OF THE INVENTION

It is an object of the present invention to provide a new and improved system for producing color modifiable light.

It is another object of the present invention to provide a system as described above that is capable of modifying the color of the produced light to any defined range within the spectrum of visible light.

It is yet another object of the present invention to provide a system as described above that produces light in an efficient manner.

It is still another object of the present invention to provide a system as described above that produces light without any peripheral display of constituent colors.

It is yet another object of the present invention to provide a system as described above that has a limited number of parts, is inexpensive to manufacture, and is easy to use.

Accordingly, as one feature of the present invention, there is provided a system for producing color transformable light, the system comprising (a) a light source for producing an excitation light of a first wavelength, and (b) a color transformer for absorbing and reemitting at least a portion of the excitation light as a wavelength modified light of a second wavelength that is distinct from the first wavelength, (c) wherein the color transformer is adapted to adjustably mix relative amounts of the excitation light and the wavelength adjustable light to yield an output light that is color modifiable.

Various other features and advantages will appear from the description to follow. In the description, reference is made to the accompanying drawings which form a part thereof, and in which is shown by way of illustration, various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a simplified schematic representation of a first embodiment of a color transformable light system constructed according to the teachings of the present invention;

FIG. 2 is an enlarged section view of the light source and color transformer shown in FIG. 1;

FIG. 3 is a plan view of the middle layer of the color transformer shown in FIG. 2, the middle layer being shown from the perspective of its exit surface, the light emitter for the light source being shown in dashed form in relation to the middle layer to facilitate understanding of the operation of the color transformer within the system;

FIGS. 4(a)-(c) are front perspective, front plan and exploded front perspective views, respectively, of one detailed implementation of the displacement apparatus in FIG. 1, the displacement apparatus being shown with the color transformer and the light source to illustrate its functionality;

FIG. 5 is a simplified schematic representation of a second embodiment of a color transformable light system constructed according to the teachings of the present invention;

FIGS. 6(a)-(d) are front perspective, front plan, top plan and exploded front perspective views, respectively, of a third embodiment of a color transformable light system constructed according to the teachings of the present invention;

FIG. 7 is a front perspective view of the color transformer shown in FIG. 6, the red and green color transforming regions of the color transformer being shown demarcated with a dashed line for ease of understanding;

FIG. 8(a) is a fragmentary, section view of the color transformer shown in FIG. 7, taken along lines 8a-8a; and

FIG. 8(b) is a fragmentary, section view of the color transformer shown in FIG. 7, taken along lines 8b-8b.

### DETAILED DESCRIPTION OF THE INVENTION

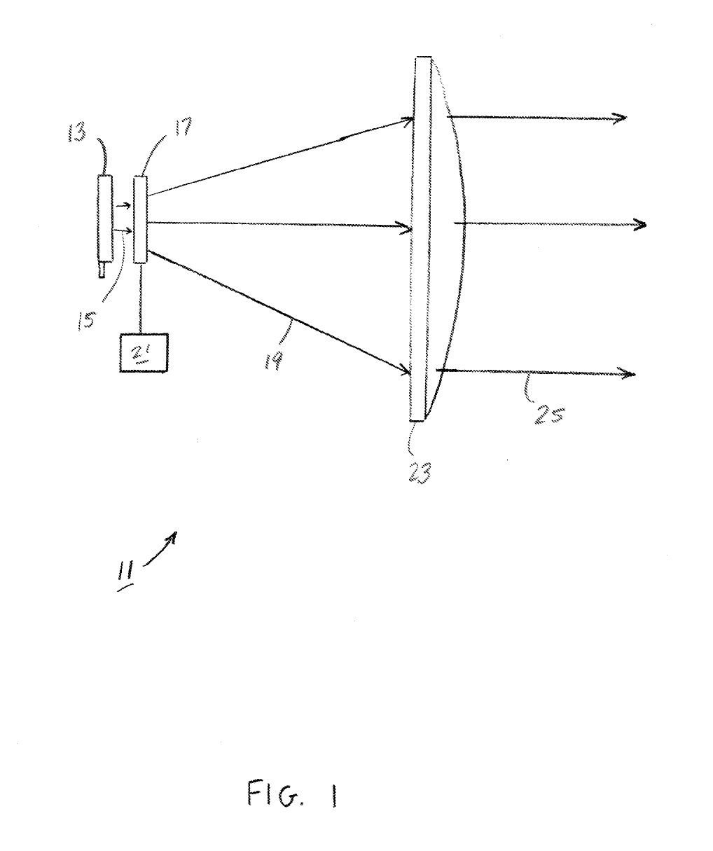

Referring now to FIG. 1, there is shown a first embodiment of a color transformable light system constructed according to the teachings of the present invention, the system being identified generally by reference numeral 11. As will be explained further in detail below, system 11 is specifically designed to efficiently produce light having a color that can be modified within a defined range in the spectrum of visible light, which is a principal object of the present invention.

System 11 comprises a light source 13 for producing source, or excitation, light 15 of a defined wavelength and a color transformer, or mixer, 17 for absorbing and reemitting at least a portion of source light 15 as wavelength modified light 18 that is adjustably mixed with excitation light 15 to yield unfocused, output light 19. As referenced briefly above, mixer 17 enables output light 19 to be efficiently produced in any color within a defined range in the spectrum of visible light.

System 11 additionally comprises a displacement apparatus 21 that is fixedly coupled to color transformer 17. As will be described further below, apparatus 21 retains color transformer 17 a fixed distance away from light source 13 but, at the same time, allows for lateral and vertical displacement (i.e. displacement in the X and Y directions) of color transformer 17 relative to light source 13 in order to achieve the desired wavelength of output light 19.

Lastly, system 11 comprises an optional optical component 23 that is positioned relative to color transformer 17 so as to direct unfocused, output light 19 into a properly mixed, pseudo-collimated beam to yield focused, output light 25. It should be noted that optical component 23 is precisely positioned relative to color transformer 17 to ensure that output light 25 is efficiently and properly mixed. More specifically, color transformer 17 is preferably located at the focal point of optical component 23 to ensure that output light 25 is properly mixed and focused.

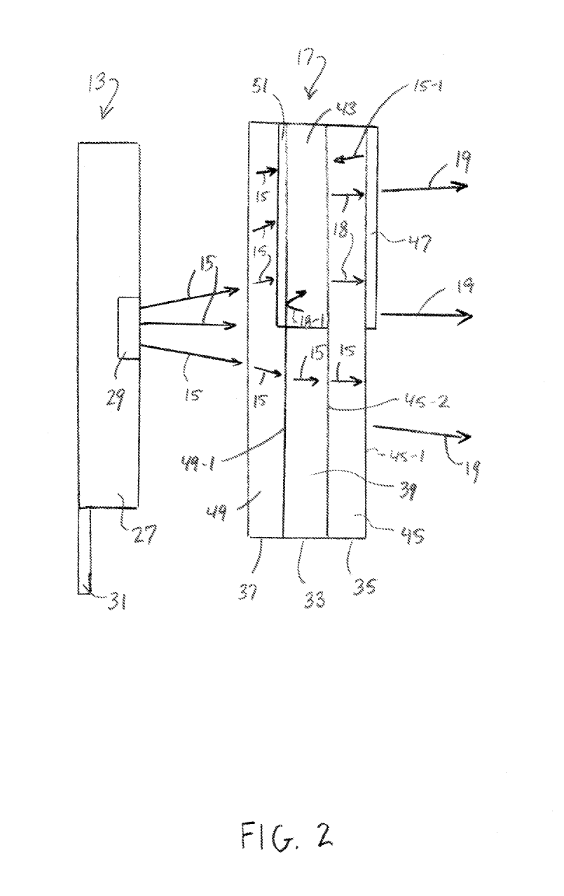

Light source 13, which is shown in greater detail in FIG. 2, is preferably a single light emitting diode (LED) that is designed to produce excitation light 15 which has a wavelength that falls within the blue range of the visible light spectrum. For example, light source 13 may be in the form a blue LED sold by Luminus Devices, Inc., of Billerica, Mass. under model number CBT90, the aforementioned LED being designed to produce light with a wavelength between approximately 400-410 nm.

To facilitate its use and construction, light source 13 preferably includes a conductive board 27 on which is mounted a flat, square-shaped, die-type, light emitter 29 and a pair of voltage contact terminals 31. However, it is to be understood that the particular construction of light source 13 could be modified to suit the needs of the intended application.

It should be noted that light source 13 is preferably designed to include a single light emitter 29 to resolve mixing issues typically associated with a light source that emits light from multiple, separate emitters (i.e. diffuse light that does not originate from the same point).

It should also be noted that light source 13 is preferably in the form of a color LED to maximize light efficiency and minimize power consumption requirements.

Referring now to FIG. 2, color transformer 17 is preferably constructed as a thin, flat, generally square-shaped, unitary component that includes a plurality of layers stacked in a front-to-back relationship. As seen most clearly in FIG. 2, a middle layer 33 is disposed between an outer, or cover, layer 35 and an inner layer 37, with layers 33, 35, and 37 secured together by any suitable means, such as through the application of an adhesive (not shown) between adjacent surfaces.

Layers 33, 35 and 37 share generally identical, square-shaped dimensions and are aligned together to provide color transformer 17 with a uniform, flattened, peripheral edge. However, it is to be understood color transformer 17 is not limited to the square-shaped overall footprint shown herein. Rather, it is to be understood that color transformer 17 could be designed with a different overall shape (e.g. an annular shape) without departing from the spirit of the present invention, as will be explained further in detail below.

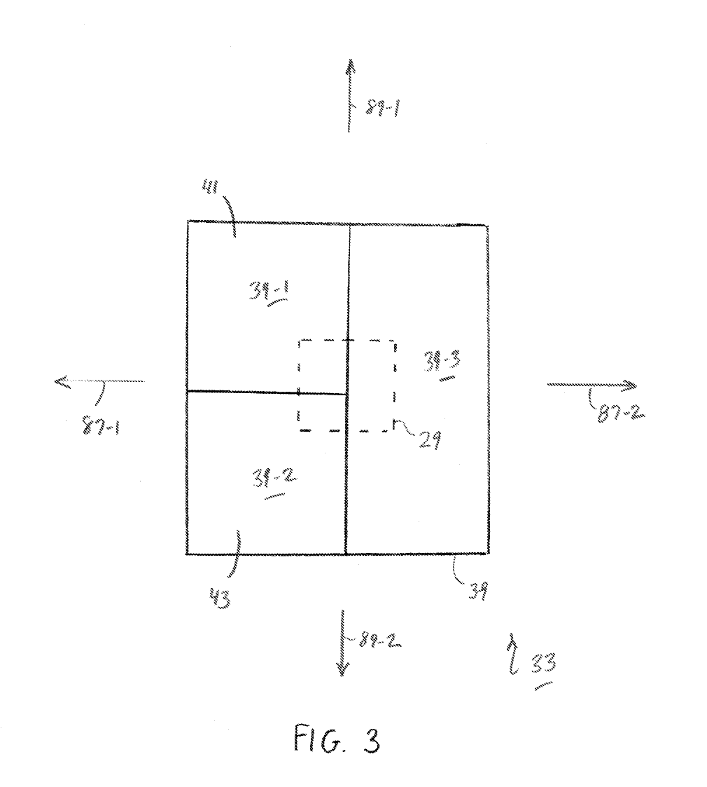

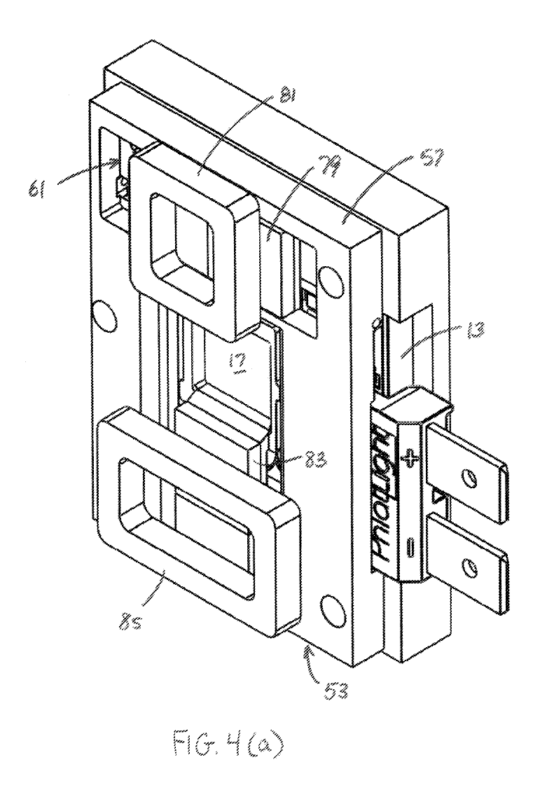

As seen most clearly in FIG. 3, middle layer 33 includes a transparent slide 39 that is preferably constructed out of glass or another similar thermally conductive, transparent material. The upper left hand quadrant 39-1 of slide 39 is applied with a material 41 for transforming the wavelength of blue light into a wavelength that falls within the red range of the visible light spectrum. Similarly, the lower left hand quadrant 39-2 of slide 39 is applied with a material 43 for transforming the wavelength of blue light into a wavelength that falls within the green range of the visible light spectrum. As a result, the remainder of slide 39 (i.e. the right half 39-3 of slide 39) remains transparent. Accordingly, by regulating the amount of blue light that is either directed through the transparent portion of slide 39, or transformed by materials 41 or 43, the aforementioned constituent colors (namely, blue, green and red) can be efficiently mixed to create light of any color within a defined range in the visible light spectrum, as will be explained further below.

Light transformative materials 41 and 43 could be in the form of phosphors. For instance, material 41 could be in the form of a red phosphor currently sold by PhosphorTech Corporation of Kennesaw, Ga. as product number HTR650, the red phosphor converting light to a wavelength centered at approximately 650 nm. Similarly, material 43 could be in the form of a green phosphor currently sold by PhosphorTech Corporation of Kennesaw, Ga. as product number HTG540, the green phosphor converting light to a wavelength centered at approximately 540 nm.

However, it should be noted that materials 41 and 43 need not be limited to phosphors. Rather, it is to be understood that materials 41 and 43 represent any product capable of transforming light to the designated wavelength range. For instance, materials 41 and 43 could be in the form of quantum dots, or other similar light transformative material, without departing from the spirit of the present invention.

If phosphors are utilized in color transformer 17, middle layer 33 is preferably constructed by mixing the appropriate phosphor powder in a transparent protective binder, or encapsulant, such as silicone. It is to be understood that the concentration of the phosphor powder utilized must be carefully established to maximize the amount of light emitted within the desired wavelength range. If the concentration of phosphor powder is too small, a large percentage of the excitation light (i.e. the blue light) may be transmitted without conversion into the desired wavelength range. By contrast, if the concentration of the phosphor powder is too large, the phosphor powder itself may block light transformed into the desired wavelength range, resulting in the emission of a limited quantity of light. In fact, the ideal concentration of phosphors typically results in a quantity of the blue excitation light muting the red and/or green light emitted by the phosphors.

Referring back to FIGS. 2, outer layer 35 includes a transparent slide 45 that is preferably constructed out of glass or another similar thermally conductive, transparent material. The left half of slide 45 is preferably applied with a thin-film, dichroic filter 47 on its outer, or exit, surface 45-1 (or, in the alternative, on its inner surface 45-2). Filter 47 is preferably in the form of a 495 nm fluorescence dichroic filter that serves to reflect, or block, blue excitation light (as represented by light 15-1) while, at the same time, selectively pass all light having wavelengths greater than 495 nm (i.e. wavelength adjusted light 18). In this manner, filter 47 not only prevents blue excitation light 15 from escaping through the left half of color transformer 17 but also reflects such light back into light transformative materials 41 and 43, thereby increasing the overall light absorptive efficiency of color transformer 17, which is highly desirable.

Inner layer 37 similarly includes a transparent slide 49 that is preferably constructed out of glass or another similar thermally conductive, transparent material. The left half of slide 49 is preferably applied with a thin-film, dichroic filter 51 on its outer, or exit, surface 49-1. Filter 51 is preferably in the form of a 475 nm shortpass filter that serves to selectively pass all light having wavelengths under 475 nm (e.g. blue light 15) to pass while, at the same time, to reflect, or block, all light having wavelengths over 475 nm (e.g. green and red wavelength adjusted light, as represented by light 18-1). In this manner, filter 51 not only enables blue excitation light 15 to be efficiently absorbed by light transformative materials 41 and 43 but also reflects longer wavelength light emitted from materials 41 and 43 so as to be directed in the proper propagation direction (i.e. away from light source 13 and out through cover layer 35), thereby maximizing the efficiency of color transformer 17.

For ease of illustration, filters 47 and 51 are shown as being applied to selected regions of separate of transparent slides 45 and 49, respectively, which are in turn affixed to middle layer 33 as part of a subsequent assembly process. However, it is to be understood that color transformer 17 could be alternatively constructed without the use of transparent slides 45 and 49 by directly applying filters 47 and 51 to the outer (i.e. exit) and inner (i.e. entry) surfaces, respectively, of middle layer 33 without departing from the spirit of the present invention. In other words, the entirety of outer layer 35 and inner layer 37 could be in the form of filters 47 and 51, respectively, which are applied to opposing, exposed surfaces of middle layer 33 in the regions of wavelength transformation.

Referring back to FIG. 1, displacement apparatus 21 is shown herein in a simplified fashion as being fixedly coupled to color transformer 17. It is to be understood that apparatus 21 represents any device that is capable of moving color transformer 17 linearly in two dimensions.

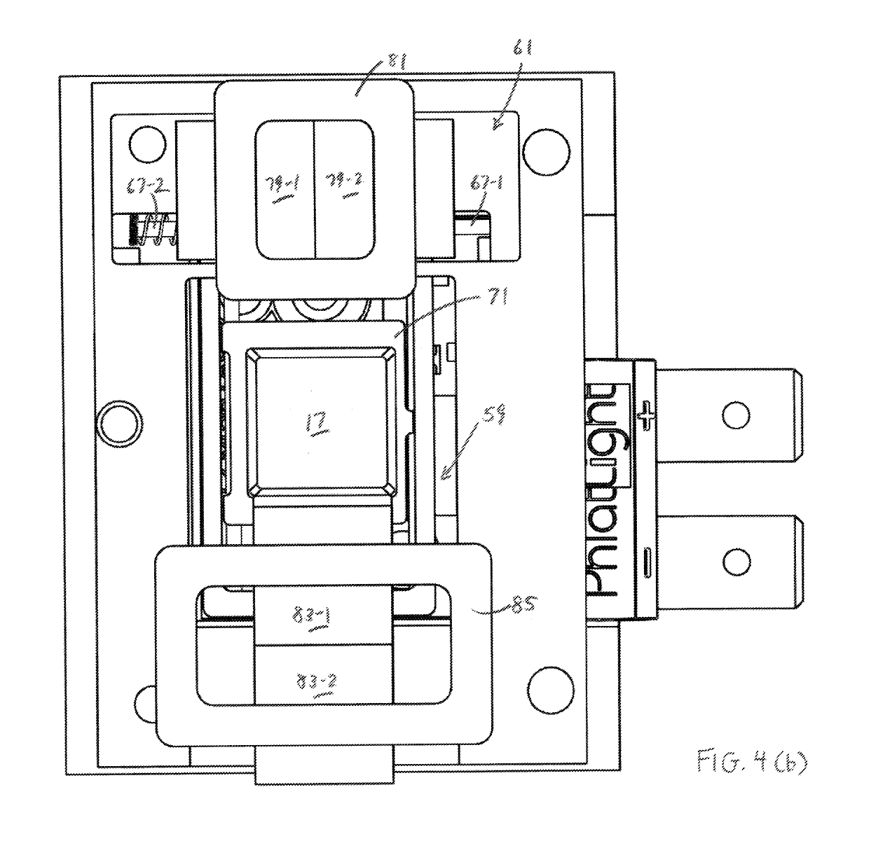

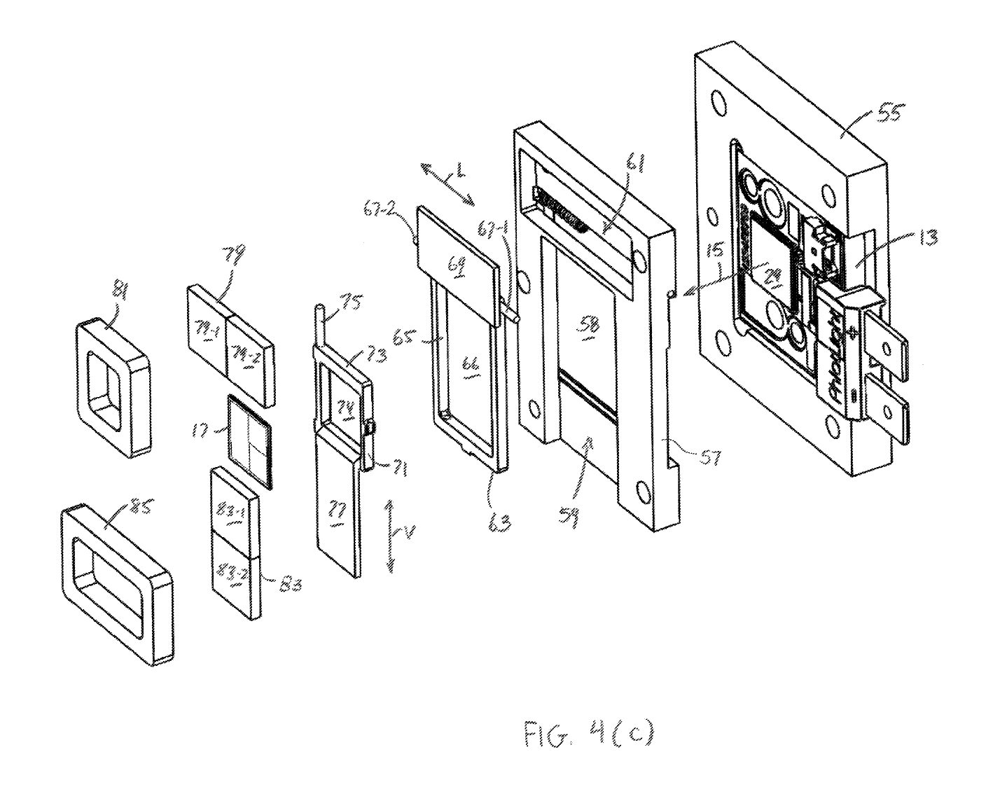

For instance, referring now to FIGS. 4(a)-(c), there is shown one implementation of an apparatus for linearly displacing color transformer 17 in two dimensions relative to light source 13, the apparatus being identified generally by reference numeral 53. As will be explained in detail below, apparatus 53 utilizes a pair of independently-operating linear motors to displace color transformer 17 along two orthogonal paths.

As seen most clearly in FIG. 4(c), light source 13 is preferably fixedly mounted onto a generally rectangular base, or block, 55 such that emitter 29 is positioned to freely emit excitation light 15. Preferably, block 55 is constructed of a thermally conductive material, such as copper, that can be used to assist in the thermal transfer of heat produced by light source 13 during its operation (i.e. to function as a heat sink).

A plastic frame 57 is fixedly mounted onto the front surface of base 55 over light source 13 using suitable fastening elements, such as transversely driven screws (not shown). Frame 57 is constructed as an enlarged, rectangular member that is shaped to define a central window 58 disposed in direct alignment with emitter 29. In this manner, excitation light 15 produced by emitter 29 penetrates through window 58 of frame 57 in an unencumbered fashion.

The front surface of frame 57 is additionally shaped to include a vertically-oriented cavity, or channel, 59 and a horizontally-oriented cavity, or channel, 61. As will be explained further below, cavities 59 and 61 restrict displacement of color transformer 17 along vertical and horizontal paths, respectively.

An outer stage 63 is coupled to frame 57 and is capable of horizontal, or lateral, displacement relative thereto. Outer stage 63 includes an open, rectangular mount 65 that extends within cavity 59 in frame 57. Outer stage 63 additionally includes a pair of co-linear alignment pins 67-1 and 67-2 that extend laterally outward from opposing sides of mount 65 and, in turn, project into corresponding bores, or tracks, formed in frame 57 within horizontal cavity 61. As such, pins 67 limit outer stage 63 to lateral displacement along a linear path, as represented by arrows L. Lastly, outer stage 63 includes a flat plate 69 formed on the front surface of mount 65 along its top edge, plate 69 being sized, shaped and positioned to slide linearly within horizontal cavity 61.

An inner stage 71 is coupled to outer stage 63 is capable of vertical displacement relative thereto. Inner stage 71 includes an open, square-shaped mount 73 that nests within a central opening 66 in rectangular mount 65. Inner stage 71 additionally includes an upwardly projecting alignment pin 75 that fittingly protrudes through a hole formed in rectangular mount 65. As such, pin 75 limits inner stage 71 to vertical displacement along a vertical path, as represented by arrows V. Lastly, inner stage 71 includes a flat plate 77 formed on the front surface of mount 73 along its bottom edge and that projects downwardly therefrom, plate 77 being sized, shaped and positioned to slide linearly within the lower half of vertical cavity 59.

Preferably, color transformer 17 is disposed within a central opening 74 defined in inner stage 71 and is secured thereto about its periphery using a suitable adhesive, such as silicone. As such, excitation light 15 produced by emitter 29 travels through frame 57, outer stage 63 and inner stage 71 and, in turn, into color mixer 17.

As mentioned briefly above, apparatus 53 utilizes a pair of independently-operating linear motors to displace color transformer 17 relative to light source 15. Specifically, a first magnet 79, which includes opposing polarity sections 79-1 and 79-2 arranged in a side-by-side relationship, is affixed to the exposed front surface of plate 69 on outer stage 63. In turn, a coil 81 is fixedly mounted onto plastic frame 57 directly over first magnet 79. Accordingly, upon the application of current into coil 81, magnet 79 causes movable stage 63 to translate horizontally in one direction. Reversal of the direction of movable stage 63 can be subsequently accomplished either using a return spring, which activates upon withdrawal of the applied current, or by applying reverse polarity current into coil 81.

Similarly, a second magnet 83, which includes opposing polarity sections 83-1 and 83-2 arranged in a top-to-bottom relationship, is affixed to the exposed front surface of plate 77 on inner stage 71. In turn, a coil 85 is fixedly mounted onto plastic frame 57 directly over second magnet 83. Accordingly, upon the application of current into coil 85, magnet 83 causes movable stage 71 to translate vertically in one direction. Reversal of the direction of movable stage 71 can be subsequently accomplished either using a return spring, which activates upon withdrawal of the applied current, or by applying reverse polarity current into coil 85.

Referring back to FIGS. 1 and 2, apparatus 21 preferably retains color transformer 17 a minimal, fixed distance away from light emitter 29 of light source 13, color transformer 17 and light source 13 being shown adequately spaced apart in the present drawings only for ease of illustration. In particular, apparatus 21 preferably retains color transformer 17 as close as possible to light emitter 29 but without direct contact, since color transformer 17 will need to be displaced in relation to light source as part of the color mixing process, as will be described further in detail below.

It should be noted that when either (i) a very high intensity light source 13 is utilized and/or (ii) the distance between light emitter 29 and phosphor materials 41 and 43 is increased, the absolute temperature of both phosphor materials 41 and 43 as well as light emitter 29 is lowered. This lowering in temperature increases not only the reliability but also the total emitted light output, or efficiency, of system 11, which is highly desirable.

Additionally, it should be noted that color transformer 17 may be encapsulated within air or a particular liquid (e.g. mineral oil or silicone oil) to more accurately match the refractive index of phosphor materials 41 and 43, as well as to provide additional cooling to light emitter 29 and phosphor materials 41 and 43, which facilitates higher optical power density.

As referenced briefly above, system 11 comprises an optional optical component 23 that is positioned relative to color transformer 17 so as to direct unfocused, output light 19 into a properly mixed, pseudo-collimated beam to yield focused, output light 25. In the present embodiment, optical component 23 is represented as a lens. In use, color transformer 17 is preferably located at the focus of optical component 23 to ensure that output light 25 is properly mixed and focused.

If, however, the distance between color transformer 17 and optical component 23 is greater than the focus for optical component 23, a pixelated image will be formed. To resolve this issue of image pixilation, the mixing process will require color intensity modulation in relation to time and position at a frequency that is not perceptible to the human eye (e.g. greater than 30 Hz).

Similarly, if the distance between color transformer 17 and optical component 23 is less than the focus for optical component 23, no real image will be formed. To resolve this issue, static mixing could be utilized to produce the desired image. As referenced briefly above, by regulating the amount of blue light that is either directed through the transparent portion of slide 39, or transformed by materials 41 or 43, the aforementioned constituent colors (namely, blue, green and red) can be efficiently mixed to create any color within a defined range in the visible light spectrum. Specifically, as seen most clearly in FIG. 3, the footprint of blue light emitter 29 is shown to assist in the explanation of the operation of system 11, even though the entirety of emitter 29 is not ordinarily visible from the exit surface of mixer 17.

In use, system 11 operates in the following manner to produce color transformable light. With system 11 constructed in the manner set forth in detail above, blue excitation light 15 is directed towards color transformer 17. As seen most clearly in FIG. 3, blue excitation light 15 emitted from light emitter 29 that transmits through right half 39-3 of transparent slide 39 retains its source wavelength (i.e. without absorption from light transformative materials 41 and 43). Accordingly, through the bi-directional displacement of color mixer 17 in the X direction, as represented by arrows 87-1 and 87-2, the amount of blue light emitted as part of output light 19 can be increased or decreased, respectively.

However, blue excitation light 15 that is directed towards and absorbed by materials 41 and 43 is reemitted as red and green (i.e. wavelength adjusted) light 18, respectively. Accordingly, as mentioned above, bi-directional displacement of color mixer 17 in the X direction adjusts the amount of blue light to be absorbed by materials 41 and 43. Additionally, through the bi-directional displacement of color mixer 17 in the Y direction, as represented by arrows 89-1 and 89-2, the relation between the amount of red light and green light emitted as part of output light 19 can be adjusted. In this manner, the total amount, or intensity balance, of blue, red and green light emitted as output light 19 can be easily and efficiently adjusted through the translation of color mixer 17 in the X direction and/or in the Y direction. As a result, the aforementioned design can be utilized to produce color transformable light within a relatively broad and detailed chromaticity triangle (i.e. light of any color within the chromaticity triangle defined by the wavelengths of the three base colors).

Displacement of color mixer 17 to achieve the desired light output can be accomplished either through (i) a series, or sequence, of temporarily static steps or (ii) continuous dynamic movement coupled with emission of light from source 13 in a strobed fashion. For the latter technique, a circular, rotatable, wheel-type construction of mixer 17 synchronized with the pulsed emission of light from source 13 may be a desirable and effective implementation (e.g. maintaining the rotation of such a wheel at a set speed and pulsing light from source 13 to achieve the desired color mixture), as will be described further in detail below.

It should be noted that pulsing, or strobing, an LED may provide the additional benefit of safely overdriving the LED with up to twice the static current. Thus, even though the pulsed LED may not continuously emit light (i.e. have a 100% duty cycle), overdriving can be utilized to help achieve full optical output.

The embodiment shown above is intended to be merely exemplary and those skilled in the art shall be able to make numerous variations and modifications to it without departing from the spirit of the present invention. All such variations and modifications are intended to be within the scope of the present invention as defined in the appended claims.

For instance, in the present embodiment, excitation light 15 produced from light source 13 expands, or diverges, outward towards color transformer 17. To create a more collimated source light 15, an elliptical reflector may be incorporated into system 11.

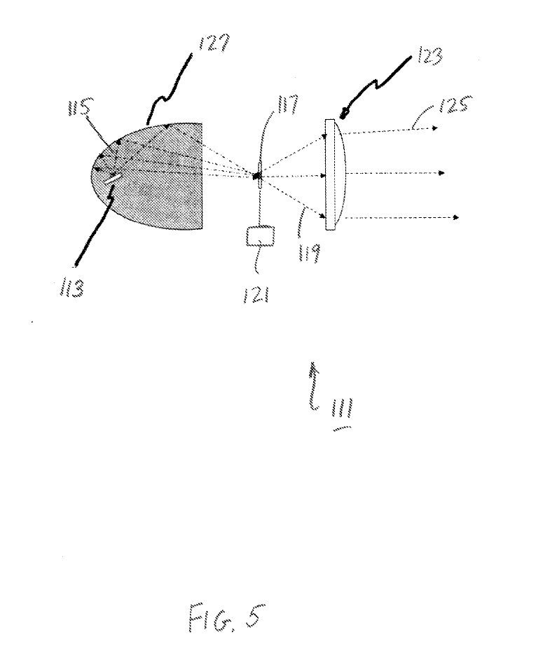

Specifically, referring now to FIG. 5, there is shown a second embodiment of a color transformable light system constructed according to the teachings of the present invention, the system being identified generally by reference numeral 111. As can be seen, system 111 is similar to system 11 in that system 111 comprises a light source 113 for producing source, or excitation, light 115, a color transformer, or mixer, 117 for transforming the wavelength of source light 115 to a desired wavelength to yield unfocused, output light 119, a displacement apparatus 121 coupled to color transformer 117 for laterally and vertically displacing (i.e. in the X and Y directions) color transformer 117 relative to light source 113, and an optional optical component 123 for directing unfocused, output light 119 into a properly mixed, pseudo-collimated beam to yield focused, output light 125.

System 111 differs from system 11 in that system 111 additionally includes an elliptical reflector 127 that at least partially surrounds light source 113. Accordingly, with light source 113 preferably located at one focus of elliptical reflector 127, excitation light 115 can be converged and directed to color transformer 117, which is located at the other focus of elliptical reflector 127. By maintaining color transformer 117 at the focal point for optical component 123, further collimation, or focusing, of output light 125 can be achieved. Additionally, the incorporation of elliptical reflector 127 into system 111 allows for light source 113 and color transformer 117 to be adequately separated, which may be beneficial in certain applications.

As referenced briefly above, an effective and desirable implementation of system 11 may be achieved by reconstructing color mixer 17 to be rotationally displaced (e.g., as a wheel) and, in turn, synchronizing the orientation of the reconstructed color mixer 17 with intensity modulated pulses of excitation light from source 13.

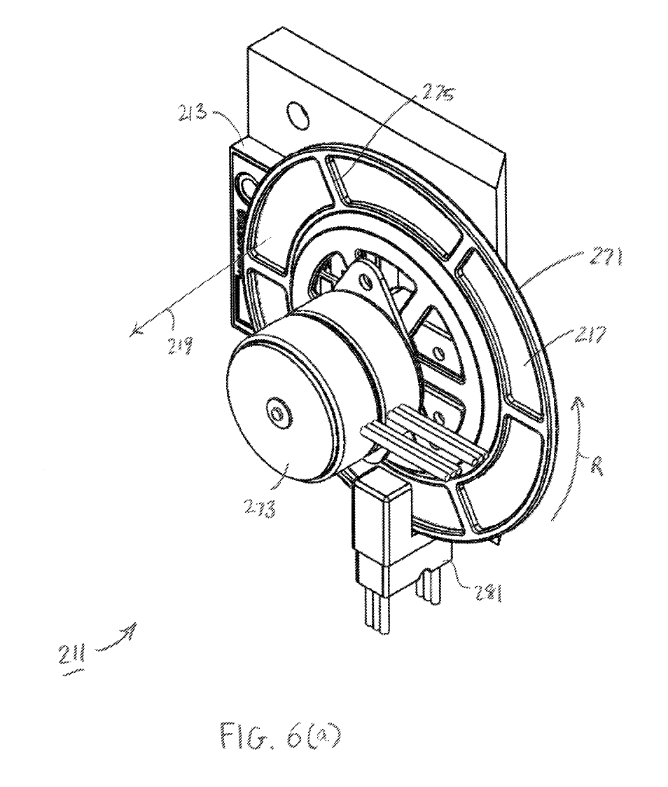

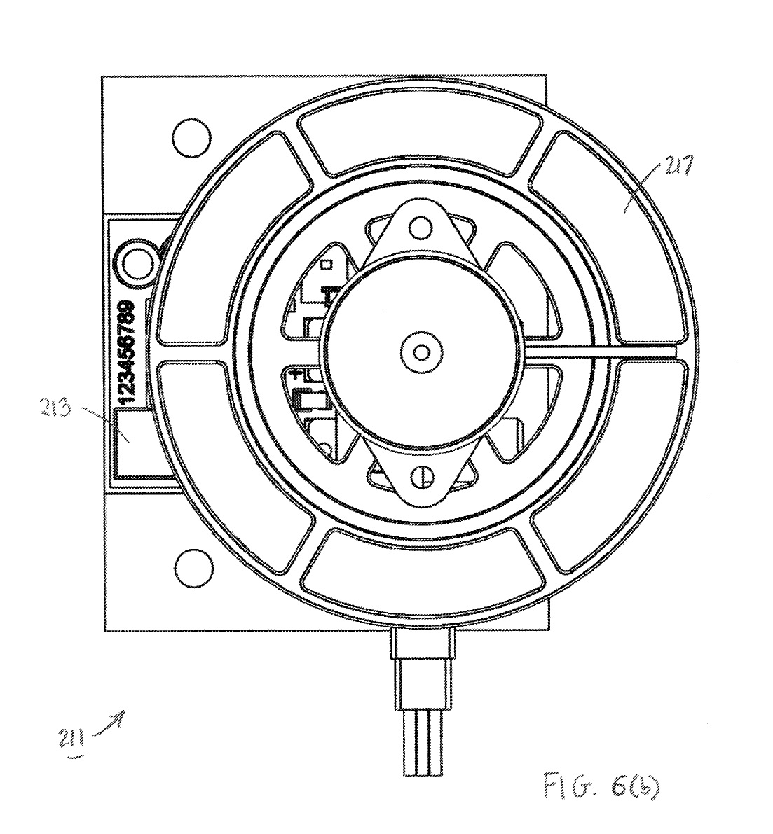

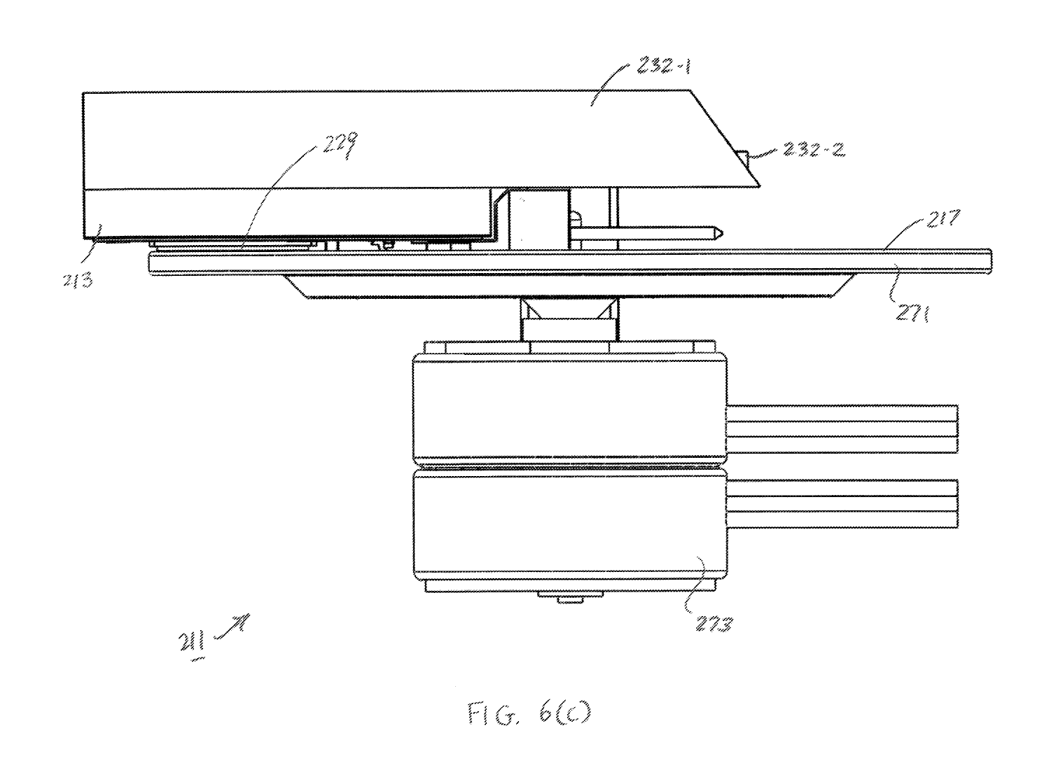

Specifically, referring now to FIGS. 6(a)-(d), there is shown a third embodiment of a color transformable light system constructed according to the teachings of the present invention, the system being identified generally by reference numeral 211. As can be seen, system 211 is similar to system 11 in that system 211 comprises a light source 213 for producing source, or excitation, light 215, a color transformer, or mixer, 217 for selectively transforming the wavelength of source light 215 to produce wavelength modified light 218, and a displacement apparatus 221 coupled to color transformer 217 for moving color transformer 217 relative to light source 213 in order to mix excitation light 215 with wavelength modified light 218 to yield output light 219 of a desired color.

As seen most clearly in FIG. 6(d), light source 213 is similar to light source 13 in that light source 213 is preferably in the form of a single light emitting diode (LED) that is designed to produce excitation light 215 which has a wavelength that falls within the blue range of the visible light spectrum. In the present embodiment, light source 213 is constructed as a modular component that includes a flat, square-shaped, die-type, light emitter 229 and a pair of voltage contact terminals 231. A heat sink 232 is shown thermally coupled to light source 213 and serves to transfer away, and thereby assist in the subsequent cooling of, heat produced by emitter 229.

As represented in FIG. 6(c), heat sink 232 includes a generally flat conductive plate 232-1 that is directly mounted onto light source 213 and a heat transfer tube 232-2 that projects out from plate 232-1 and serves as a conduit through which a heat-transfer fluid (not shown) passes. However, it is to be understood that alternative types of heat sinks could be used in place thereof to assist with heat dissipation without departing from the spirit of the present invention.

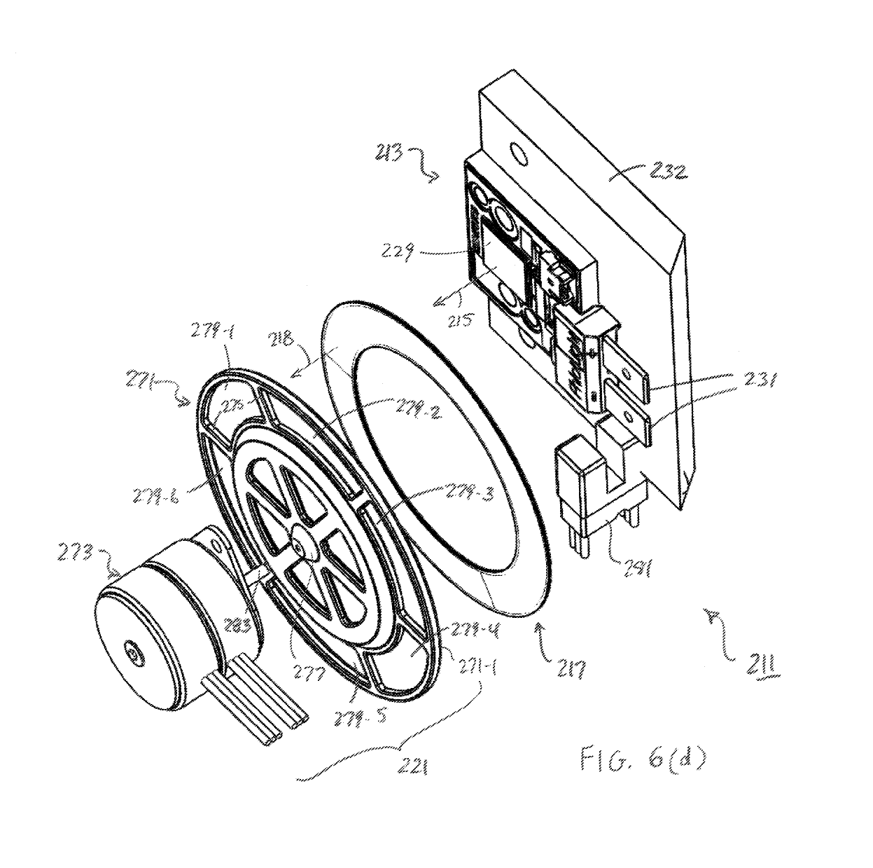

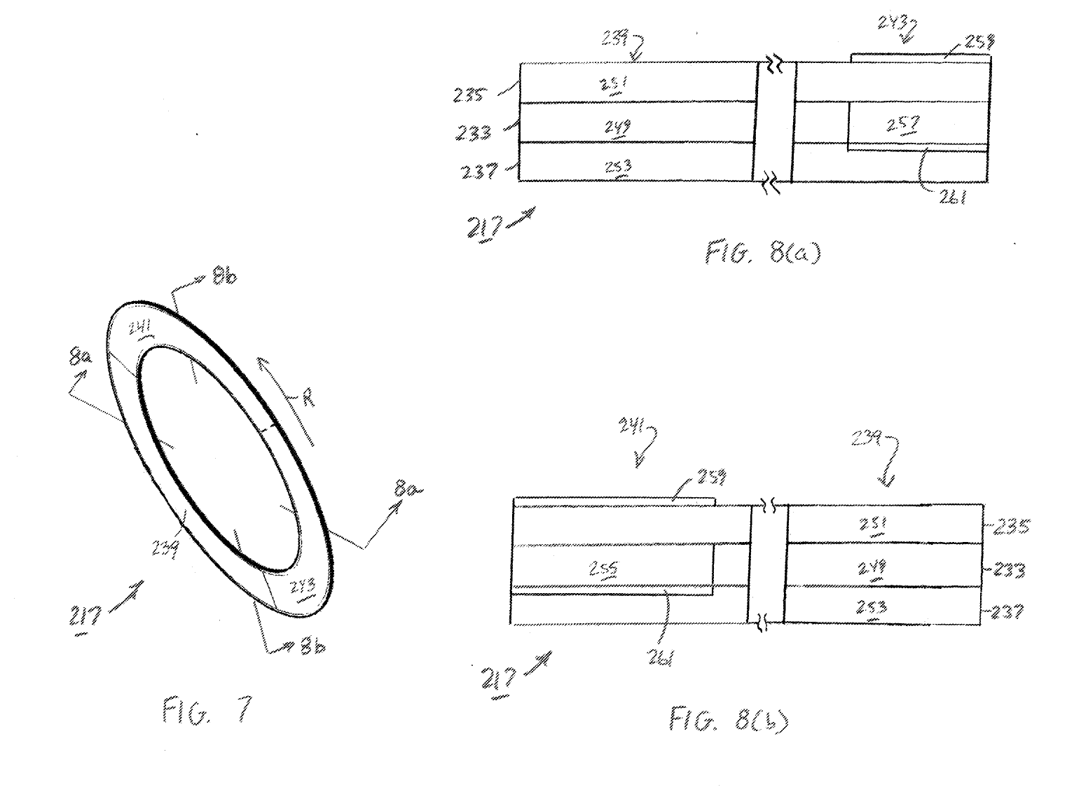

As seen most clearly in FIGS. 7, 8(a) and 8(b), color transformer 217 is similar in construction to color transformer 17 in that color transformer 217 includes a middle layer 233 disposed between an outer layer 235 and an inner layer 237. Together, layers 233, 235 and 237 define a transparent, or wavelength unmodified light, region 239, a first wavelength modified light region 241 and a second wavelength modified light region 243. In a similar fashion to color transformer 17, first wavelength modified light region 241 is designed to transform blue excitation light 215 into light with a wavelength that falls within the red range of the visible light spectrum. Furthermore, second wavelength modified light region 243 is designed to transform blue excitation light 215 into light with a wavelength that falls within the green range of the visible light spectrum. Accordingly, by selectively positioning the various regions of color transformer 217 in front of emitter 229 and, in turn, synchronizing pulses of excitation light 215, modifiable amounts of blue, red and green light can be rapidly mixed together to produce output light 219 of a particular color triangle (i.e. light of any color within the chromaticity triangle defined by the wavelengths of the three base colors).

Similar to the construction of color transformer 17, layers 233, 235 and 237 of color transformer 217 include transparent slides 249, 251 and 253, respectively. As seen most clearly in FIG. 8(b), within region 241, transparent slide 249 for middle layer 233 is applied with a material 255 for transforming the wavelength of blue light into a wavelength that falls within the red range of the visible light spectrum (e.g. a red phosphor). Likewise, as seen most clearly in FIG. 8(a), within region 243, transparent slide 249 for middle layer 233 is applied with a material 257 for transforming the wavelength of blue light into a wavelength that falls within the green range of the visible light spectrum (e.g. a green phosphor).

Additionally, a first thin-film, dichroic filter 259 is applied to the exit surface of transparent slide 251 for outer layer 235 within regions 241 and 243. Likewise, a second thin-film, dichroic filter 261 is applied to the exit surface of transparent slide 253 for inner layer 233 within regions 241 and 243. In use, filters 259 and 261 function in a similar fashion as filters 47 and 51 in that filters 259 and 261 ensure that excitation light 218 is efficiently absorbed within regions 241 and 243 and, in turn, reemitted as wavelength modified light 218 in the proper direction.

Color transformer 217 differs primarily from color transformer 17 in that color transformer 217 has an annular construction, with regions 239, 241 and 243 arranged as contiguous, 120 degree, arcuate sections rather than as one or more quadrants of a rectangular member. As a result, system 211 is designed to most effectively mix colors through rotation of color transformer 217 about its center axis, as represented by arrow R in FIG. 6(a).

It should be noted that the particular number and arrangement of color regions in transformer 217 is not limited to the representation set forth herein. Rather, it is to be understood that the particular number and arrangement of color regions in annular transformer 217 could be modified without departing from the spirit of the present invention. For instance, additional wavelength modifiable regions could be incorporated into color transformer 217 to increase the number of base colors available for color mixing.

Referring back to FIGS. 6(a)-(d), rotation of color transformer 217 is achieved in the present embodiment through the use of a motor-driven, wheel-type displacement apparatus 221. Specifically, apparatus 221 includes a rigid, annular wheel 271 that is rotationally driven by a motor 273. Motor 273 is preferably fixedly secured to a stationary object (not shown), such as an optical component for focusing output light 219, so that regions 239, 241, 243 of color transformer 218 align directly with emitter 229 in a close, yet slightly spaced apart, relationship, as shown in FIG. 6(c).

Wheel 271 is a flat annular member constructed out of any suitably rigid and durable material. Color transformer 217 is fixedly coupled to the rear surface 271-1 of wheel 271 by any suitable means, such as through the use of an adhesive.

Wheel 271 is shown as including a plurality of spokes 275 that extend radially out from a central hub 277 in an equidistantly spaced apart relationship. As such, spokes 275 serve not only to provide structural rigidity to wheel 271 but also to define a series of arcuate, peripheral windows 279-1 thru 279-6, with each window 279 positioned to align with a portion of at most one of regions 239, 241 and 243 in color transformer 217 (i.e. only one color region aligns within each window 279).

A fixedly mounted sensor 281 is positioned to detect spokes 275 in wheel 271. Accordingly, sensor 281 can be used to determine the exact moment when each of regions 239, 241 and 243 is in direct alignment in front of emitter 229. Therefore, by connecting sensor 281 and light source 213 to a common processor (not shown), the intensity of excitation light 215 pulsed from emitter 229 can be synchronized with the momentary position of each of regions 239, 241 and 243 in front of emitter 229, as will be explained further below.

Motor 273 is represented herein as a stepper motor 273 that includes a cylindrical rotor 283 that fittingly penetrates through central hub 277 in wheel 271. Accordingly, activation of motor 273 causes color transformer 217 to rotate along a circular path about rotor 283 (i.e. as represented by arrow R in FIG. 6(a)), preferably at a constant rate that is suitable for color mixing (e.g. at approximately 120 rotations per minute).

In use, system 211 is a designed to operate in the following manner to produce color transformable light. With system 211 constructed in the manner set forth in detail above, motor 273 preferably rotates wheel 271 at a fixed rate so that regions 239, 241 and 243 alternate in direct alignment in front of emitter 229 for a defined period. Since sensor 281 is able to detect spokes 275 in wheel 271 and thereby determine the exact moment that each of regions 239, 241 and 243 is disposed directly in front of emitter 229, a processor in electrical connection with sensor 281 and light source 213 can both synchronize and modulate the intensity of excitation light 215 pulsed from emitter 229 to produce output light 219 of a particular color by rapidly mixing the three constituent colors (i.e. blue, green and red). In other words, by varying the relative amounts of each base color, the aforementioned design can be utilized to produce light of any color within the chromaticity triangle defined by the wavelengths of the three base colors.

As a particularly notable advantage of above-described embodiment, the relatively disperse arrangement of color transformable regions 241 and 243, as well as the continuous rotation of color transformer 217, limits the duty cycle for each of wavelength transformable materials 255 and 257 (e.g. the red and green phosphors). By limiting the duration that materials 255 and 257 are heated by excitation light 215, the lifespan of materials 255 and 257 can be substantially extended, which is highly desirable. Furthermore, this ability to prevent materials 255 and 257 from prematurely wearing out enables system 211 to readily produce output light 219 of a very bright, white color, if desired.

What is claimed is:

1. A system for producing color transformable light, the system comprising:
(a) a light source for producing an excitation light of a first wavelength; and
(b) a color transformer for absorbing and reemitting at least a portion of the excitation light as a wavelength modified light of a second wavelength that is distinct from the first wavelength;
(c) wherein the color transformer is adapted to adjustably mix relative amounts of the excitation light and the wavelength adjustable light to yield an output light that is color modifiable.

2. The system as claimed in claim 1 further comprising an apparatus coupled to the color transformer for displacing the color transformer relative to the light source in order to adjustably mix the relative amounts of the excitation light and the wavelength modified light.

3. The system as claimed in claim 2 wherein the apparatus is adapted to rotationally displace the color transformer relative to the light source

4. The system as claimed in claim 2 wherein the apparatus is adapted to translationally displace the color transformer in two dimensions.

5. The system as claimed in claim 1 further comprising an optical component for directing the output light, the optical component having a focal point.

6. The system as claimed in claim 5 wherein the color transformer is located at the focal point for the optical component.

7. The system as claimed in claim 1 wherein the color transformer is adapted to absorb and reemit at least a portion of the excitation light as a wavelength modified light of a third wavelength, the third wavelength being distinct from the first and second wavelengths.

8. The system as claimed in claim 7 wherein the color transformer is adapted to adjustably mix relative amounts of the excitation light of the first wavelength, the wavelength adjustable light of the second wavelength, and the wavelength adjustable light of the third wavelength to yield the output light.

9. The system as claimed in claim 8 wherein the color transformer includes a first layer comprising:
(a) a transparent slide; and
(b) a first color transformative material applied to a first region of the transparent slide, the first color transformative material being adapted to absorb and reemit the excitation light as the wavelength modified light of the second wavelength.

10. The system as claimed in claim 9 wherein the first layer of the color transformer additionally comprises a second color transformative material applied to a second region of the transparent slide, the second color transformative material being adapted to absorb and reemit the excitation light as the wavelength modified light of the third wavelength.

11. The system as claimed in claim 10 wherein each of the first and second color transformative materials is a phosphor material.

12. The system as claimed in claim 11 wherein each of the first and second color transformative materials is a phosphor powder encapsulated within the transparent slide.

13. The system as claimed in claim 10 wherein the color transformer additionally includes a second layer and a third layer between which the first layer is disposed, the third layer being positioned between the light source and the first layer.

14. The system as claimed in claim 13 wherein at least a portion of the second layer is applied with a dichroic filter for blocking light of the first wavelength and selectively passing light of the second and third wavelengths.

15. The system as claimed in claim 14 wherein at least a portion of the third layer is applied with a dichroic filter for selectively passing light of the first wavelength and blocking light of the second and third wavelengths.

16. The system as claimed in claim 10 wherein the light source is a single light emitting diode (LED).

17. The system as claimed in claim 16 wherein the excitation light produced by the light emitting diode is blue in color.

18. The system as claimed in claim 17 wherein the first color transformative material absorbs and reemits the excitation light as wavelength modified light that is red in color.

19. The system as claimed in claim 18 wherein the second color transformative material absorbs and reemits the excitation light as wavelength modified light that is green in color.

20. A system for producing color transformable light, the system comprising:
(a) a light source for producing an excitation light of a first wavelength; and
(b) a color transformer adapted to absorb and reemit at least a portion of the excitation light as a wavelength modified light of a second wavelength and a wavelength modified light of a third wavelength, each of the first, second and third wavelengths being distinct from one another;
(c) wherein the color transformer is adapted to adjustably mix relative amounts of at least two of the excitation light, the wavelength modified light of a second wavelength and the wavelength modified light of a third wavelength to yield an output light that is color modifiable.
